(19) United States
(12) Patent Application Publication
(10) Pub. No.: US 2014/0356847 A1
(43) Pub. Date: Dec. 4, 2014

(54) Learning Tool

(71) Applicant: Christine Albietz, Moreno Valley, CA (US)

(72) Inventor: Christine Albietz, Moreno Valley, CA (US)

(21) Appl. No.: 13/903,955

(22) Filed: May 28, 2013

(51) Int. Cl. G09B 1/00

(52) U.S. Cl. CPC G09B 1/00
USPC 434/411

(57) ABSTRACT

A learning device has been described. The components of the system and methods of use are included. The device has been shown to be generally useful in providing organizational structure and memory techniques to enhance learning in a variety of subject areas. In one embodiment the device is made from printed erasable card stock. In another embodiment the learning device is incorporated into a program that controls a computing device to display and enable interaction with the learning device as shown on a display. In yet another embodiment the device is projected on a wall or screen using a computer and a projector.

### CROSS-REFERENCE TO RELATED APPLICATIONS

Not Applicable.

### BACKGROUND OF THE INVENTION

1. Technical Field

The present invention relates to a learning device for use in a classroom setting and methods of use.

2. Related Background Art

Various tools and aids for use in a classroom setting have been around since the dawn of teaching in a group setting. Teachers use blackboards, whiteboards, overhead projectors and, more recently, projected computer screens to display important points and concepts. The common theme of these devices is that a concept becomes more cognitively ingrained if the student both hears and sees images that will help the student remember and make associations. The students use paper and pencil to take notes or, now, computers and computing tablet devices. Textbooks and workbooks may be available that are specific to a particular topic and include diagrams, outlines and subject specific content. There have also been attempts to aid in communication between student and teacher and amongst students through handheld displays such as handheld chalkboards and whiteboards that can be held up for others to see an individual student's results.

There are some basic concepts of learning that are common to a host of subjects. The concept of flow, order, a first step, a second step and so on may seem trivial to some but for people with learning disorders or differences and even those with normal learning abilities, organizing thoughts and concepts to provide a coherent and memorable story is often a difficult task. In writing, the ordering of a sentence may be subject, verb, object with modifiers of adjectives and adverbs “attached” to this core. Similarly a paragraph may be ordered into an introductory sentence, one or two explanatory sentences and a concluding sentence that may repeat or link back to the introductory sentence. In math equations flow left to right such as 1+2=3 or a+b=c. To understand the concepts of the formula, each element of the formula shown is considered in turn, the elements of the first formula being numbers 1,2,3 and symbols + and =.

These are not concepts taught or used just at the elementary level. Law school students both in school and preparing for the bar exam are often coached into using a writing structure such as IRAC a mnemonic for Issues, Rules, Analysis, Conclusions or one of many variations thereof to help structure both legal documents and exam answers. Patent applications usually have a standard structure with headings and content that flows from a title, first paragraph of related applications, background of the invention . . . to the claims. Learning that such structure exists, that it is commonplace and an aid to communication which helps people move forward on tasks is an important skill to be learned.

Another aspect of structured flow is seen in memory mnemonics. People who are known to memorize long lists of items such as a names of people in a group or a list of numbers also often use a serial flow of images or experiences with which they can associate each item to be memorized in a list. The use of a “memory palace” as an aid to memorize a list of items is well known. A person may have a personal memory palace as a series of images that are so ingrained in the person's memory that they can always be restated. A typical memory palace would be a series of objects that a person sees when they walk through their home. In memorizing a list, an association is established between the items of the list and the objects in the memory palace such that visualizing a stroll through their home enables the person to recount the items in the list.

There are proven tools and structures that are inherent and common to many aspects of our learning culture. There are, however, no known learning devices that incorporate the use of both common organizational structures and useful mnemonic techniques that can additionally be utilized to address individual learning styles and needs. There is a need for such a learning device that provides aid to students and teachers in organizing thoughts and concepts for tasks involving comprehension and/or expression into a form that is commonly known and accepted across subjects.

The discussions here will demonstrate designs and methods applied specifically to a simple mechanical learning device. Those skilled in the art will readily see the applicability to other devices in the form of both simple physical mechanical devices and learning software.

### DISCLOSURE OF THE INVENTION

The present invention provides a learning tool that embodies the concepts of helping to enhance memory skills, organize thinking, address individual learning styles/needs and other items. In a preferred embodiment the organization is linear. The linearity may be related to time, location or other concepts where one item should logically precede another. In a preferred embodiment the tool is an elongated foldable card that includes indicia in the form of a sequence of numbered, colored squares. The preferred embodiment also includes other indicia indicating before and after, past, present and future, minus/less and plus/more, left and right. In one embodiment the card is laminated with a plastic material such that the card may be used with erasable markers such that the user may use the card to organize items along the indicia of the card. In one embodiment the card is also a memory mnemonic where a list of items to be memorized are placed along the visible indicia. A user of the card may then associate items with one or more of the card indicia and, recalling the sequence of the indicia of the learning device card, allows the user to recall the sequence of items. In one embodiment the card is sized to be hand held. In a preferred embodiment the card is made of multiple sections that are joined with flexible hinges such that the card may be folded or unfolded to allow for adjustment of task length and/or level of difficulty as well as for use or ease of carriage and storage. In another embodiment the indicia are on one side of the linked cards and the reverse side of the cards is blank to allow more free form use.

In another embodiment the device is in the form of a display. In one embodiment the learning device is in the form of an erasable blackboard or, as is more common today, a white board using erasable markers. In another embodiment the device is displayed on the screen of a computing device. And in yet another embodiment the device is projected on a wall or screen using a computer and a projector.

### BRIEF DESCRIPTION OF THE DRAWINGS

FIG. 1 is a diagram showing the front side of a learning device.

FIG. 2A is a diagram showing a single first section of the device of FIG. 1.

FIG. 2B is a diagram showing a second embodiment of that shown in FIG. 2A.

FIG. 3 is a diagram showing a single second section of the device of FIG. 1.

FIG. 4 is a diagram showing a single third section of the device of FIG. 1.

FIG. 5 is a diagram showing a single fourth section of the device of FIG. 1.

FIG. 6 is a diagram showing use of an embodiment of the device for teaching counting.

FIG. 7 is a diagram showing use of an embodiment of the device for teaching the memorization of word lists and symbols.

FIG. 8 is a diagram showing use of an embodiment of the device for teaching organization of a narrative or story.

FIG. 9 is a diagram showing use of an embodiment of the device for teaching sentence structure.

FIG. 10 is a diagram showing an embodiment of the device that allows more customization.

FIG. 11 is a diagram showing the structure of a preferred embodiment and the backside of the device.

FIG. 12 shows use of the device for teaching basic arithmetic.

FIG. 13 shows use of the device for teaching paragraph structure.

FIG. 14 shows a computing device programmed to include the learning device.

### MODES FOR CARRYING OUT THE INVENTION

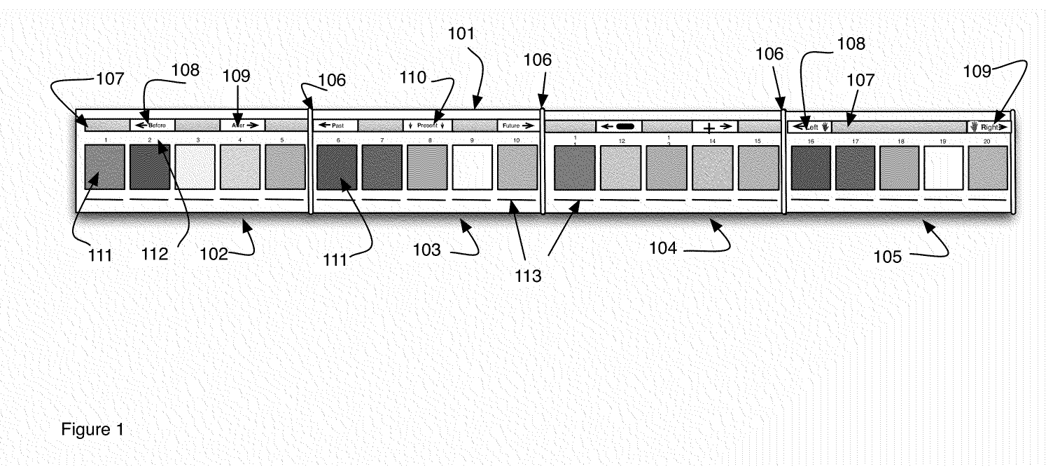

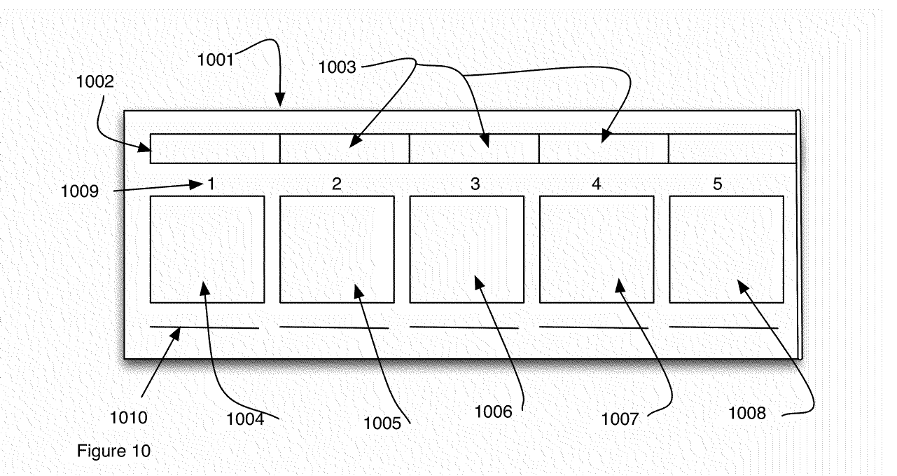

Referring to FIG. 1 a first embodiment of a learning device is shown. The device 101 is seen to consist of multiple sections 102, 103, 104, 105. Each section is joined to the other using a hinge 106. The device includes a top banner 107 that appears as a series of lighter and darker rectangles joined to form a line across the length of the device. Within the banner are included indicia 108, 109, 110 that are used to indicate directionality or some other organizational criteria. More detailed views and descriptions of these banner indicia are included below. The device further includes indicia in the form of colored squares 111 that are each sequentially numbered 112. The squares are arranged in a line across the face of the device. In a preferred embodiment there are 5 squares per card segment 102, 103, 104,105. The squares each being colored differently to aid in remembering the sequence of the squares. In a preferred embodiment the coloring of the squares in each card section 102, 103, 104, 105 is distinguishable and memorable. In the embodiment shown the squares in card section 102 are brighter and include primary colors whereas other section may include pastels, grey levels, etc. The individual indicia squares are further serialized by color. In a preferred embodiment the colors of the squares in card sections go from cool to warm colors for squares left to right. In another embodiment the tone of the squares go from dark to light (or light to dark). In another embodiment (not shown) the squares use distinguishing fill patterns for each square. In another embodiment also shown below in FIG. 10 the individual squares are blank and the user may add their own distinguishable and memorable indicia to each square. The device further includes lines 113 below each square that may be used for adding content associated with each of the indicia squares. In a method of use discussed below the lines are used by an instructor to provide feedback to a student user of the learning device.

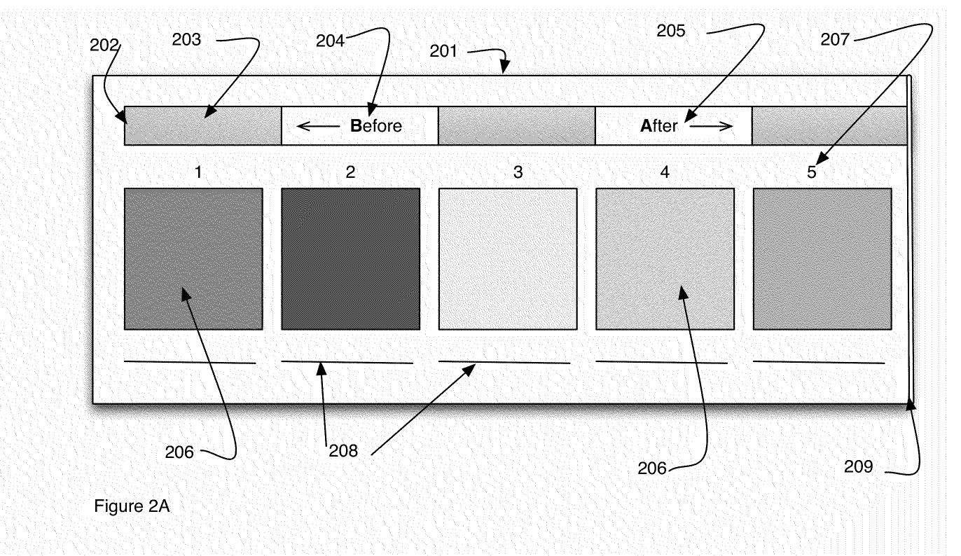

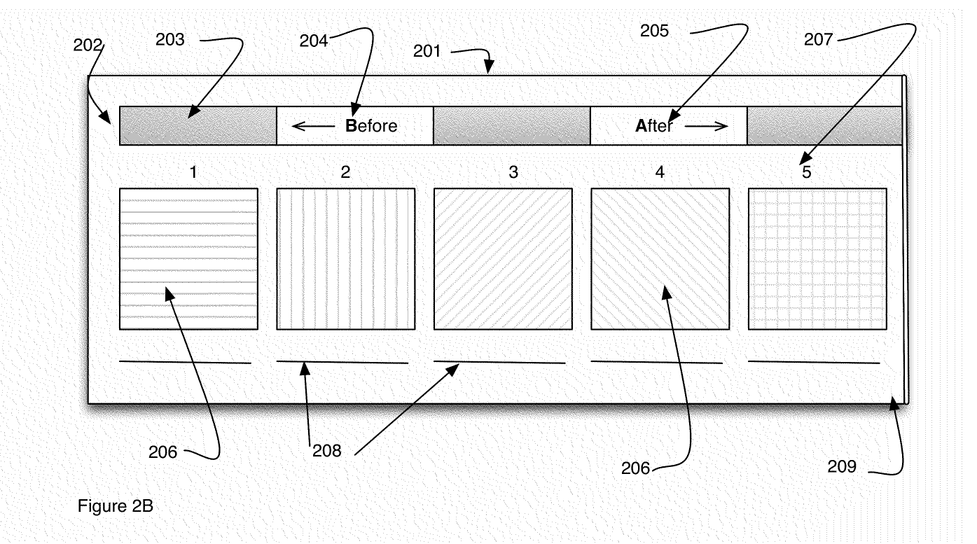

Referring now to FIG. 2A, the details of a section of the learning device are shown. The section 201 is seen to include a top banner rectangle 202 that is itself comprised of a series of rectangles. Representative rectangles include a blank rectangle 203 and information rectangles 204, 205. The information rectangles include indicia indicating time/directionality. In the embodiment shown the indicia include showing a temporal directionality of before 204 and after 205. In another embodiment the indicia are further color coded such that the words and the associated direction indicators are of a common direction. A nonlimiting example would encode all indicia showing a direction to the right colored red and all indicia indicating a left direction colored blue. In that fashion the user can then automatically know without being able to read that the words are indicating a direction associated with the arrows. The section 201 further includes a series of squares 206 that are numbered 207 above and include lines 208 for entry of information related to the squares above. In another embodiment, not shown, the lines 208 are omitted and the space below the individual squares is left blank to allow for writing. The squares 206 are colored to distinguish one square from the other. In a preferred embodiment the squares are colored first with primary colors transitioning to cool then warm colors in the sequence from left to right. In another embodiment, not shown, the squares use other indicators assigned to each square such that each square is uniquely defined. In one embodiment as shown the unique indicator is a color of the square, in another embodiment not shown the indicator is a geometric figure drawn within the square. In another embodiment the indicator is the background shading of each square. The section finally includes a hinge 209 for connection to another section. In the particular embodiment shown the section would be a first section with a single hinge 209 shown at the right hand end and no hinge at the left hand end of the section. In another embodiment shown in FIG. 2B the patterns that distinguish the individual squares 206 are patterns of lines.

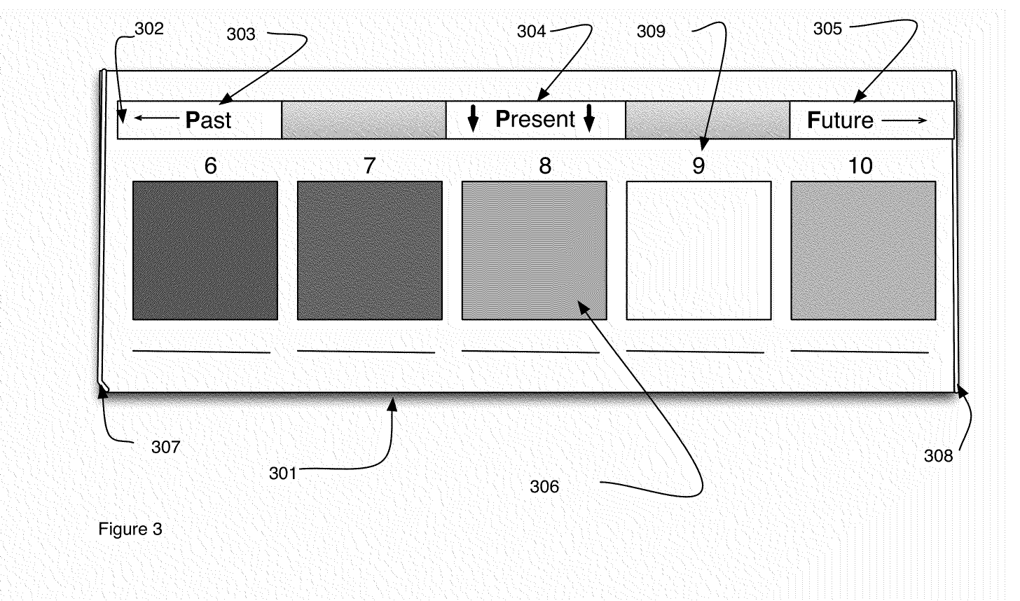

The details of another of the several sections of the embodiment of FIG. 1 are shown in FIG. 3. The section 301 again includes an information bar 302 that is comprised of a series of rectangles of which rectangles 303, 304, 305 include temporal/directionality indicators. The remaining rectangles, not numbered, are blank. In the embodiment shown the indicators 303, 304, 305 are temporal/verb tense indicators and include past 303, present 304 and future 305. The location and arrows associated with the indicators 303, 304, 305 suggest to the user that the squares 306 to the left would be used for items in the past those in the middle would be used for items in the present and those to the right would be used for items that represent or are to take place in the future. The section further includes hinges 307, 308 for attachment to other sections to create a multi-section embodiment as shown and discussed in FIG. 1. The squares 306 are colored and sequentially numbered 309 to allow each square to be uniquely identified. The coloring is selected such that it can be distinguished from the coloring for the other individual sections shown and discussed in FIGS. 2, 4 and 5.

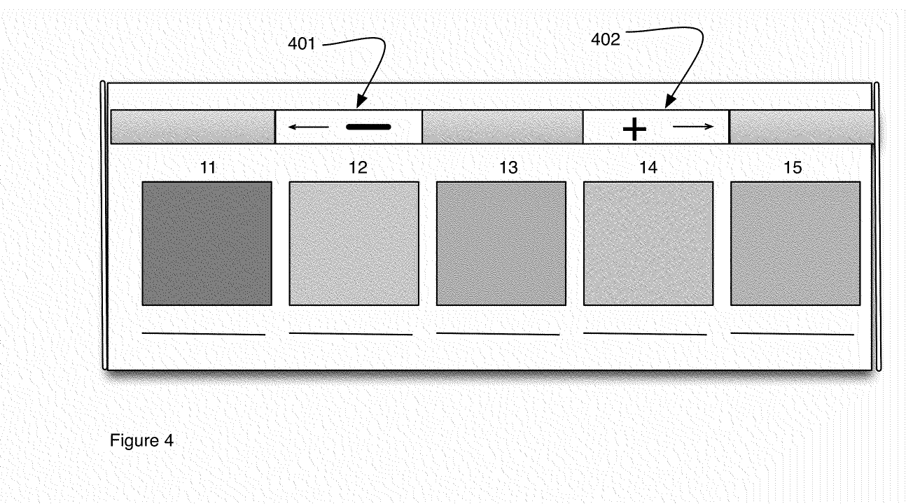

Yet another section is shown in FIG. 4. The section is comprised of components already discussed in conjunction with the previous sections. In this embodiment the direction indicators 401, 402 are simply plus 402 and minus 401 signs to indicate directionality on a number line for addition and subtraction process and numerical concepts higher/lower, more/less.

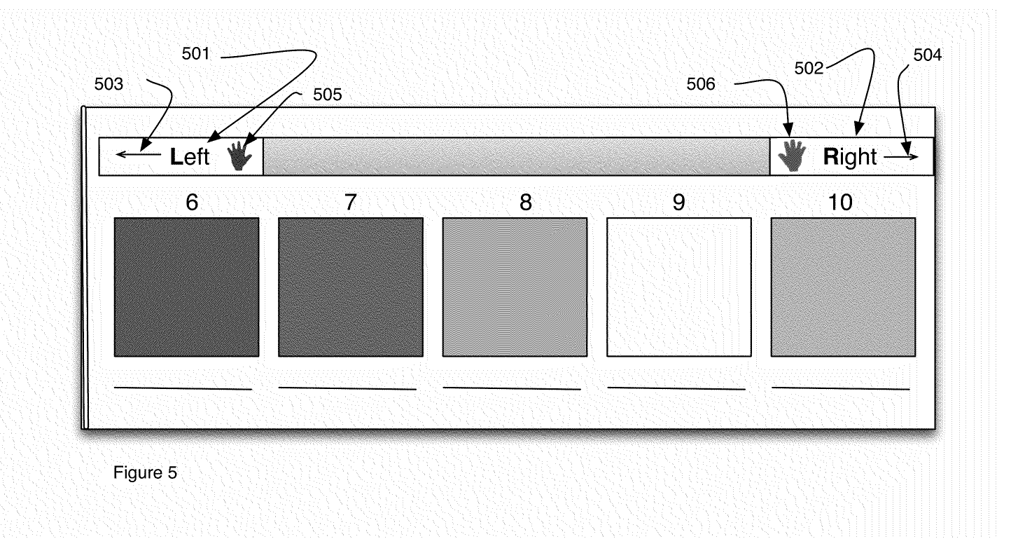

Another section is shown in FIG. 5. Again components already discussed are included but not discussed here. In the embodiment of FIG. 5 the directional indicators include indicia that signify left and right and also indicate the common western culture convention of earlier events to the left, later events to the right and reading progressing from left to right. Words 501, 502, arrows 503, 504 and symbols 505, 506 all are used to indicate left and right directions.

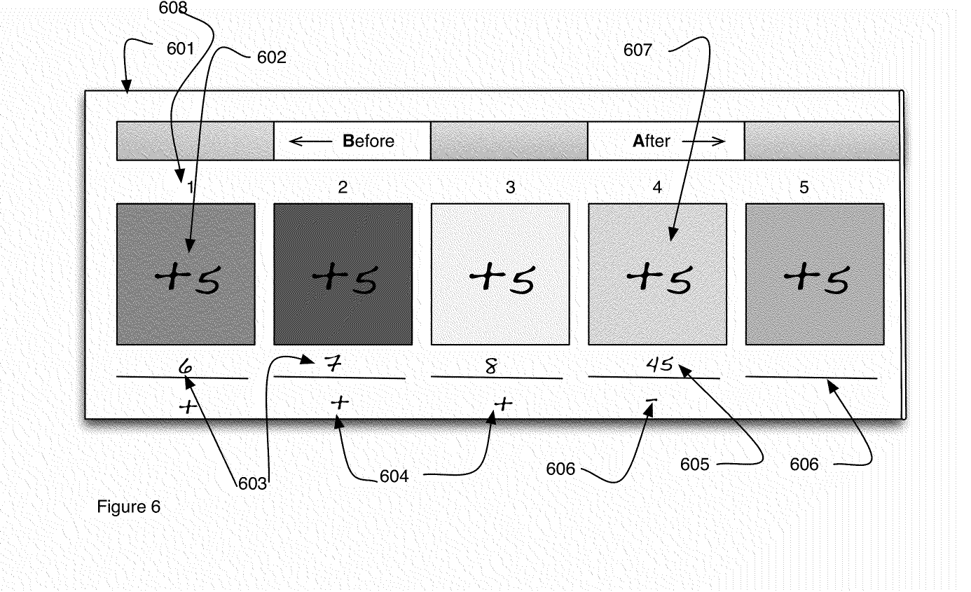

The learning device invention further includes embodiments for methods of using the device. These embodiments provide new ways of using a learning tool as well as indications of why the device design makes a learning tool applicable across a wide range of subjects. Referring now to FIG. 6, a single section 601 of the learning device shown in FIG. 1 is used in a counting instruction. In a first embodiment the instructor writes numbers 602 for the increments by which the student is to count. The student places their answers 603 on the lines below. The instructor can then grade 604 the student result with an indication that implies a correct answer (i.e. “+”) or incorrect answer (i.e. “−”). In the example shown the number “45” 605 is an incorrect answer as the next increment after 8 should be 9. The student may then correct the answer to 9 and continue with the counting exercise in the next space 606 and subsequent sections of the card (not shown). The learning device provides a structured environment, one answer per associated square, answers increment left to right in which it is safe for the student to experiment since the learning device is made of erasable card stock. The student results are easily assessed and corrected. The structure of the device allows alternatives to the same lesson; for example the instructor may provide the incremental numbers 603 and the student must provide the increments 602. In this case the student answer in the block is marked wrong 606 as the increment should have been 10.

In another embodiment not shown the device could be used for addition exercises where the number written in the square 602 is to be added to the number imprinted above the square 608. In the example shown the number 5 is to be added to the number 1 the correct answer to be written below the square 603 would in this case be 6. Similarly other arithmetic operations could be demonstrated such as multiplication division, and subtraction.

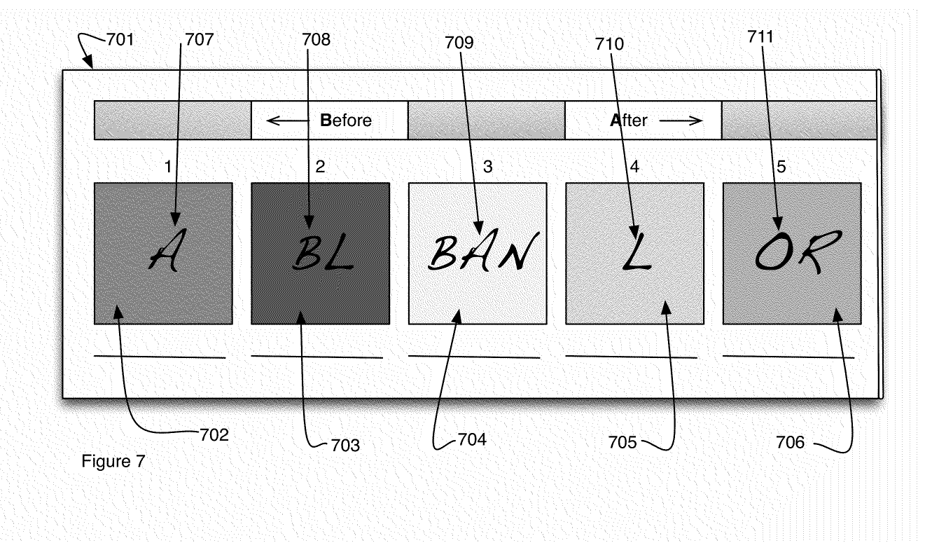

In another embodiment, shown in FIG. 7, the colors of the squares printed on the learning device are used. A section 701 of the learning device is shown. The section includes 5 numbered squares 702-706. The colors of the squares are red 702, blue 703, yellow 704, green 705 and orange 706. The task of the student is to place letters 707-711 within the colored squares that will remind the student of fruits that have the colors of the squares. A potential list is shown as A 707 for apple, BL 708 for blueberries, BAN 709 for bananas, L 710 for limes and OR 711 for oranges. The process teaches the student the use of shorthand symbols of one to three letters to represent the names of the fruit and shows a first use of the learning device as a memory mnemonic to memorize a particular list of fruit: apples, blueberries, bananas, limes and oranges. At the same time the learning device can be used for an elementary tool to aid beginning readers. The letters 707-711 are written on the device and the instructor asks the students to name a fruit beginning with that letter. The color of the squares 702-706 acts as a hint to the students. Again the learning device is seen to provide a structured learning environment with one item or answer per square. In this particular case the directionality of the learning device does not come into play.

In another embodiment the device is used as a memory mnemonic to memorize a sequence of items. The learning device comprising as already shown a plurality of flat rectangular sections, each section made from erasable card stock and joined at one edge to neighboring sections by a flexible hinge, and, each rectangular section printed on a first side with a plurality of squares each of said squares arranged linearly within the rectangular section and each square being individually distinguishable from the others by markings on each square, a rectangular bar located above the squares, the rectangular bar subdivided into a plurality of rectangles, wherein at least two of said rectangles further include indicia indicating at least one selected from: a temporal direction and a physical direction, and, a space below each of the plurality of squares that is not printed. The method of use comprising writing within each of the plurality of squares a character reminder of an item of the sequence, the characters being arranged in the sequential squares in the same order as the sequence of items, and the markings on the squares being thereby associated with the item of the sequence, memorizing the sequence of the markings and by association thereby memorizing the sequence of items. A non-limiting example of a sequence of items would be the sequence of events in a story.

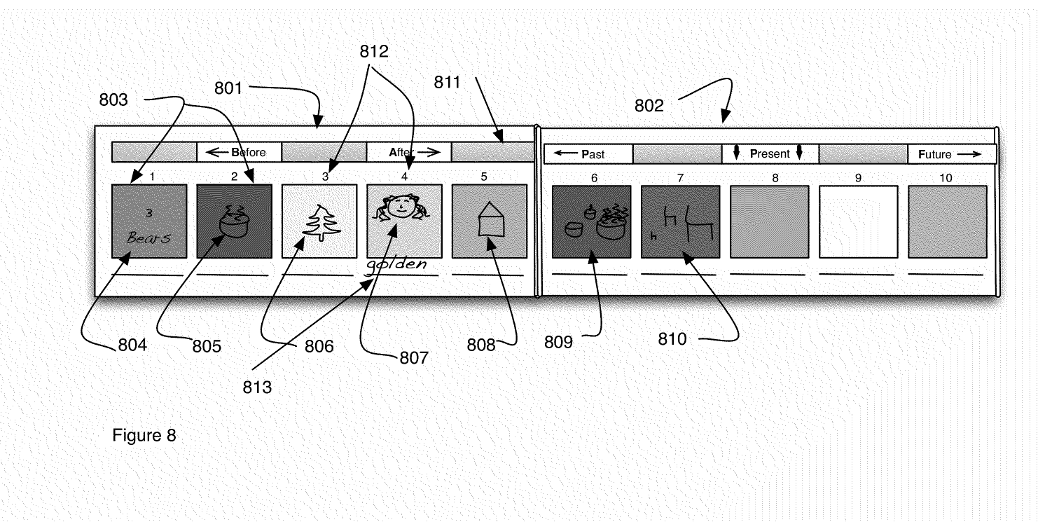

In another embodiment the learning device is used both as a memory mnemonic to aid in remembering a story or dialogue and a teaching aid for developing a story or dialogue. Referring to FIG. 8, a simplified version is shown using the story “Goldilocks and the Three Bears”. In the example shown two sections 801, 802 of the learning device are used. In other embodiments more sections are used and in yet other embodiments multiple learning devices are used. The embodiment method makes use of the individual squares 803 of the learning device. An aspect 804-810 of the story or dialogue is entered into each of the squares 803 sequentially. In the example shown, the first aspect 804 is the title of the story or, as shown, a hint to remember the opening aspect of the story. The next square 805 shows a bowl with lines rising from it to indicate that porridge was made that was too hot to eat thereby leading to square 806 where the story dialogue is related to the three bears going for a walk into the forest while the porridge cooled. The story continues with the appearance of 807 a girl with long golden locks named Goldilocks who is walking in the woods and comes upon 808 the bear's cottage. She enters the cottage and discovers 809 three different sized bowls of porridge which she tastes, each having a different number of heat lines arising from them to indicate varying temperatures. Additional information could be added as necessary that she tasted all three and completely ate all the porridge in the smallest and coolest bowl belonging to the smallest bear. Next, she tried sitting in all three sizes of chairs belonging to the bears 810 and so forth. It is seen that the user, by placing simple reminder symbols in each of the squares, can use the learning device to either remember a story to be re-told or to help structure a story as it is written. The numbering above the squares 812 and the color of the individual squares 803 acts as a memory aids such that the frequent user of the learning device uses these to remember the sequence of the story dialogue even without a view to the learning device. In the example shown, a frequent user of the card will remember the sequence of colors red, blue, yellow, green, orange for the squares numbered 1-5 respectively. The color then provides a clue as to the sequence of events using standard memory mnemonic techniques. In the example shown, the title and beginning of the story is in red 804. The second blue square 805 represents the hot porridge which could be the color of the bowls which hold the porridge. In the third yellow square 806 the story continues with the bears taking a walk along a yellow-stoned path into the forest while the porridge cools. In the fourth green square 807 a girl with long golden locks named Goldilocks wearing a pretty green dress then appears in the forest. In the fifth orange square she comes upon 808 the bears' orange cottage. In the example shown, the colorings of the square containing the story events are red 804, blue 805, yellow 806, green 807 and orange 808. The colors and the drawn indicia act as a “memory palace” to retell the story.

In another embodiment, the learning device is used in a method to structure a story or dialogue as it is written. The learning device allows the user to break the important points of the story into individual blocks 803. The learning device provides a means to outline the story or dialogue through visual clues or indicia 804-810. The writing on the learning device is erasable such that the user may develop and edit by changing and rearranging the indicia showing aspects of the story. The beginner storywriter learns that writing a story requires defining the basic concepts or events of the story. These individual events are encoded one per square 803 of the learning device. The storywriter then encodes the concepts 804-810 in a series of squares. The bar 811 at the top of the learning device provides a reminder of before and after, past present and future and so forth. The lines 813 below the individual squares are used to add modifiers or other points that should be included in that portion of the story. The individual concepts of the story are placed in a logical temporal order. The learning device is thereby used to teach fundamental concepts of organizing thoughts and ideas into a story that may be re-told to others or written.

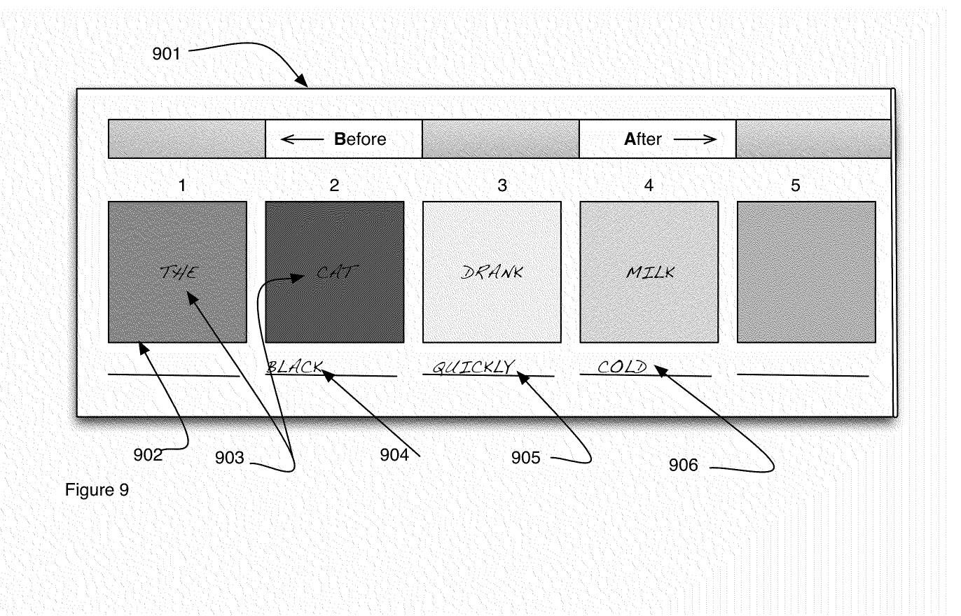

In another embodiment the learning device is used to teach basic sentence structure and expansion. As shown in FIG. 9, the learning device includes individual sequential squares 902 into which individual words 903 of the main part of a sentence are added. The lines 904-906 below the squares are used to teach modifiers. In one embodiment the instructor writes the core sentence words 903 and the student then is tasked to add the modifiers 904-906. Student answers included in the example are black 904 as an adjective for cat, quickly 905 as an adverb modifying drank and cold 906 as an adjective for milk. The student can thereby learn the basic sentence structure of subject: cat, verb: drank and object: milk and use of adjectives and adverbs to modify these basic components of a complete sentence.

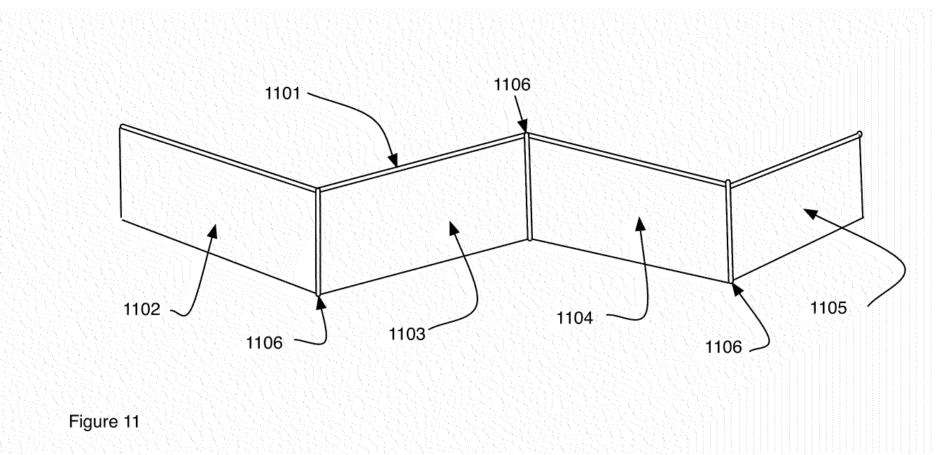

The previously presented figures and discussion provide the details of a learning device and methods of using the device to aid in teaching a variety of subjects and as a memory mnemonic. The device is further shown in FIG. 10. The learning device is composed of hinged sections, one 1001 of which is shown in FIG. 10. Each section is comprised of a top bar that is subdivided into rectangles 1003. In a preferred embodiment indicia, not shown, are included in at least two of the rectangles 1003 to indicate directionality or temporal relationship of the squares 1004-1008 located below the squares. The squares are individually identified by numbering 1009 as well as shading or coloring of the individual squares. In an example already shown the squares 1004-1008 are colored red, blue, yellow, green, orange respectively. In another embodiment the individual squares are identified by shading. In another embodiment the squares are left blank as shown in FIG. 10 and the user can add their own custom indicia to individually identify each of the squares. The learning device is comprised of a plurality of sections 1001. The overall structure of the learning device is further shown in FIG. 11. This shows a view of the backside of the learning device, the front side of the individual sections having been fully described in FIGS. 1-10. The device 1101 is comprised of a plurality of sections 1102-1105, each joined with a hinge 11-6. As shown, the hinges allow the device to be stood on edge as well as laid flat to write on the device. The device is preferably made of erasable card stock such that any writing on the device may be edited or removed for re-use. In a preferred mode, the backside is blank, thus allowing for more free form use of the learning device for both written tasks and displaying the results by holding up or standing up the device such that the front and back side of the learning device can easily be seen.

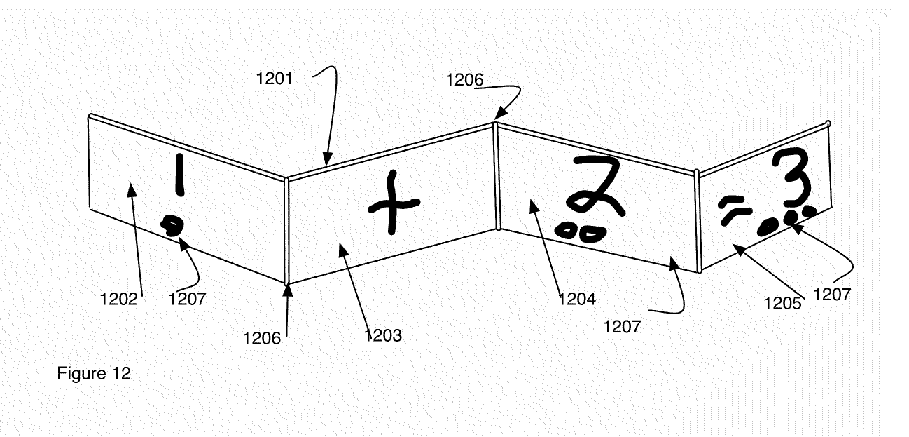

A method of using the plain backside of the learning device is shown in FIG. 12. The learning device 1201 is comprised of four sections 1202-1205, each joined to the other with a hinge 1206 such that the device may be stood up as shown in the figure. In an arithmetic lesson using the device each section 1202-1205 is used to indicate an individual part of an arithmetic equation. In this case the simple addition 1+2=3. The student is taught the structure of an equation comprising numbers 1,2,3 and symbols +, =. The instructor may write all aspects of the equation to show the structure or may provide only a subset of the parts and the student is required to add missing parts. In one example the instructor writes the contents of section 1202, 1204 and 1205 being 1,2 and =3 respectively the student is then requires to fill in the missing + in section 1203 thus providing learning and reinforcement that + operator is required to combine the numbers 1 and 2 to equal 3. The student or instructor may add further clues or teaching aids 1207 to individual sections of the learning device.

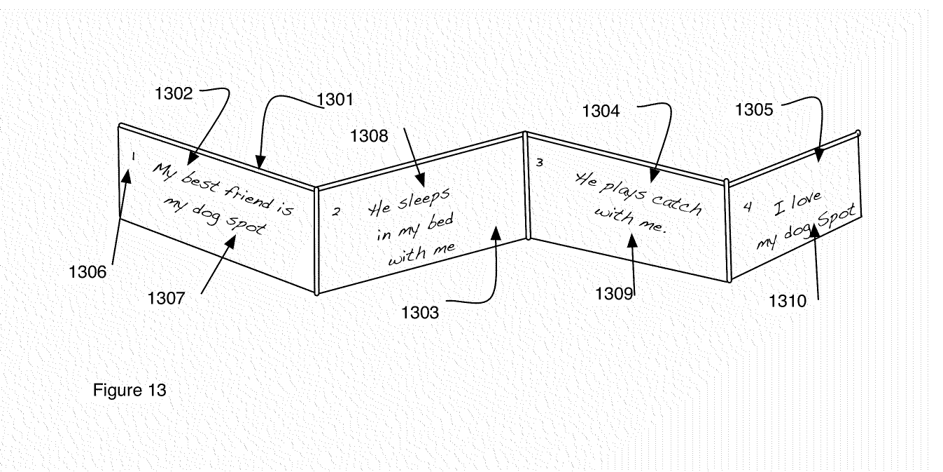

In another embodiment the sectioned structure of the learning device is used to teach the basics of paragraph structure. As shown in FIG. 13, the sections 1302-1305 of the learning device 1301 are used to show 1307-1310 the individual sentence structure of a paragraph. Numbers 1306 may be added to aid in the demonstration. In the example shown a paragraph is comprised of an introductory 1st sentence 1307, stating the basic premise of the dialogue included in the paragraph. In this case: My best friend is my dog spot. This is followed by two sentences 1308, 1309 that lend support to this introductory sentence followed by a conclusion 1310 that restates the premise of the introduction sentence 1307. The basic structure of the learning device is used to teach that a basic paragraph is comprised of four individual parts, sentences, that are laid out in a sequence.

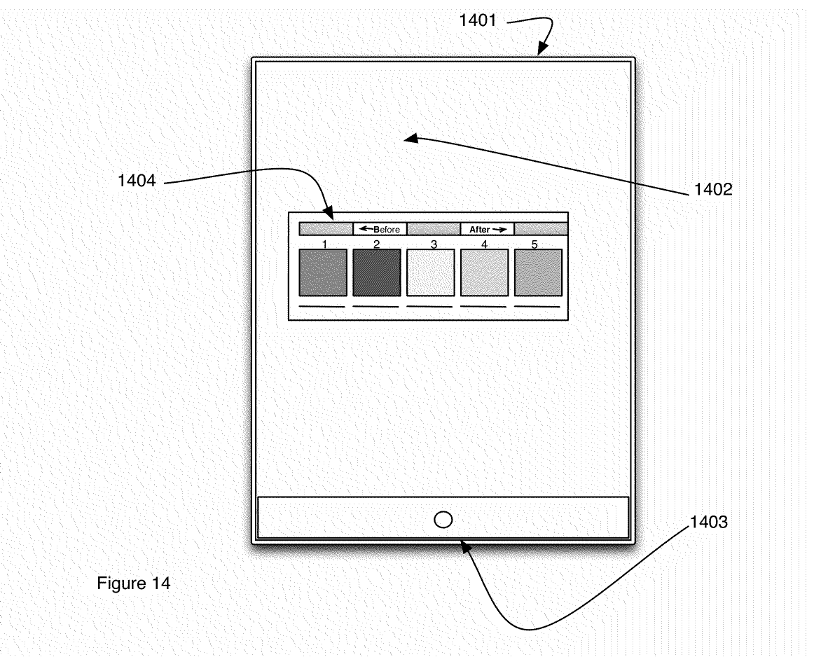

In another embodiment shown in FIG. 14 the learning device is included in a program that controls operation of a computing device 1401 such as a tablet (shown), smart phone (not shown) or personal computer (not shown). The computing device includes a display 1402 and means for user interaction 1403 as well as memory and a processor (not shown) where the memory includes programming instructions that are executed by the processor to present images on the display 1402. The means for user interaction includes buttons as shown as well as touch interactions through the display 1402 as are known in the art. The computing device is programmed to display the learning device 1404 as shown. In one embodiment the image of the learning device is used as a background field and the foreground field is a free form drawing plane that allows the user to draw and write images on top of the background field of the learning device, thereby displaying and allowing the device to be used much as has been described in the previous FIGS. 1-13. In another embodiment the multiple sequential sections of the learning device may be accessed through a touch gesture. In a preferred embodiment the touch gesture that initiates the display of an adjoining section is a swipe gesture where swiping right to left will display a subsequent section of the learning device and swiping left to right causes the device to display a prior section of the learning device. In another embodiment the display of the computing device is an electronic projector and the image of the learning device is projected on a white board or wall upon which user of the device may write and erase as already described for typical use of the device.

### SUMMARY

A learning device has been described. The components of the system and methods of use are included. The device has been shown to be generally useful in teaching a variety of subjects. In one embodiment the device is made from printed erasable card stock. In another embodiment the learning device is incorporated into a program that controls a computing device to display and enable interaction with the learning device as shown on a display. Those skilled in the art will appreciate that various adaptations and modifications of the preferred embodiments can be configured without departing from the scope and spirit of the invention. Therefore, it is to be understood that the invention may be practiced other than as specifically described herein, within the scope of the appended claims.

What is claimed is:

1. A learning device comprising:
a) a plurality of flat rectangular sections, each section made from erasable card stock and joined at one edge to neighboring sections by a flexible hinge, and,
b) each rectangular section printed on a first side with:
i) a plurality of squares each of said squares arranged linearly within the rectangular section and each square being individually distinguishable from the others by markings on each square,
ii) a rectangular bar located above the squares, the rectangular bar subdivided into a plurality of rectangles, wherein at least two of said rectangles further include indicia indicating at least one selected from: a temporal direction and a physical direction with all indicia showing a common direction of right colored the same and all indicia showing a common direction of left colored the same across all rectangular sections, and,
c) a space below each of the plurality of squares that is not printed.

2. The device of claim 1 wherein the space below each of the plurality of squares is imprinted with a line.

3. The device of claim 1 wherein the markings on each square is a solid color fill, each square being colored with a different color.

4. The device of claim 1 wherein the markings on each square are a pattern of lines, each square being printed with a pattern unique from that in the other squares.

5. The device of claim 1 wherein the squares contain no markings.

6. The device of claim 1 wherein the device consists of four flat rectangular sections.

7. The device of claim 1 wherein the indicia on the rectangular bar are an arrow pointing to a first direction and the wording “before” and an arrow pointing in a direction opposite to the first direction and the wording “after”.

8. The device of claim 1 wherein the indicia on the rectangular bar are an arrow pointing to a first direction and the wording “past” and an arrow pointing in a direction opposite to the first direction and the wording “future” and an arrow pointing in a direction perpendicular to that of the first and second arrows and the wording “present”.

9. The device of claim 1 wherein the indicia on the rectangular bar are a stylized image of a left hand and the wording “left” and a stylized image of a right hand and the wording “right”.

10. A learning device wherein the device is comprised of a computing device said computing device having a processor, a memory, a user interface and a display and said memory including programmed steps said programmed steps controlling the processor to display on the display the learning device, said learning device comprising:
a) a plurality of rectangular sections, and,
b) each rectangular section including:
i) a plurality of squares each of said squares arranged linearly within the rectangular section and each square being individually distinguishable from the others by markings on each square,
ii) a rectangular bar located above the squares, the rectangular bar subdivided into a plurality of rectangles, wherein at least two of said rectangles further include indicia indicating at least one selected from: a temporal direction and a physical direction, and,
c) a space below each of the plurality of squares that is not printed.

11. The device of claim 10 wherein the markings on each square is a solid color fill, each square being colored with a different color.

12. The device of claim 10 wherein the markings on each square are a pattern of lines, each square being printed with a pattern unique from that in the other squares.

13. The device of claim 10 wherein the user interface includes a touch screen and the display is caused to switch between a display from a first to a second rectangular section with a touch gesture.

14. The device of claim 10 wherein as the learning device is displayed, a user of the device may enter text and graphics using the user interface, said text and graphics appearing superimposed upon the learning device.

15. The device of claim 10 wherein the display is an electronic projector.

16. The device of claim 10 wherein the indicia on the rectangular bar are an arrow pointing to a first direction and the wording “before” and an arrow pointing in a direction opposite to the first direction and the wording “after”.

17. The device of claim 10 wherein the indicia on the rectangular bar are an arrow pointing to a first direction and the wording “past” and an arrow pointing in a direction opposite to the first direction and the wording “future” and an arrow pointing in a direction perpendicular to that of the first and second arrows and the wording “present”.

18. The device of claim 10 wherein the indicia on the rectangular bar are a stylized image of a left hand and the wording “left” and a stylized image of a right hand and the wording “right”.

19. A method for using a learning device as a memory mnemonic for a sequence of items,
a) said learning device comprising:
i) a plurality of flat rectangular sections, each section made from erasable card stock and joined at one edge to neighboring sections by a flexible hinge, and,
ii) each rectangular section printed on a first side with:
(1) a plurality of squares each of said squares arranged linearly within the rectangular section and each square being individually distinguishable from the others by markings on each square,
(2) a rectangular bar located above the squares, the rectangular bar subdivided into a plurality of rectangles, wherein at least two of said rectangles further include indicia indicating at least one selected from: a temporal direction and a physical direction, and,
(3) a space below each of the plurality of squares that is not printed, and
b) said method comprising:
i) writing within each of the plurality of squares a character reminder of an item of the sequence,
ii) the characters being arranged in the sequential squares in the same order as the sequence of items, and
iii) the markings on the squares being thereby associated with the item of the sequence,
iv) memorizing the sequence of the markings and by association thereby memorizing the sequence of items.

20. The method of claim 19 wherein the items are events in a story.
